(19) United States
(12) Patent Application Publication
(10) Pub. No.: US 2004/0247790 A1
(43) Pub. Date: Dec. 9, 2004

(54) Pattern formation method, device manufacturing method, electro-optical device, and electronic apparatus

(75) Inventor: Hidekazu Moriyama, Fujimi-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/827,317

(22) Filed: Apr. 20, 2004

(30) Foreign Application Priority Data
Apr. 22, 2003 (JP) 2003-117163

(51) Int. Cl. B05D 5/00

(52) U.S. Cl. 427/256; 427/421.1

(57) ABSTRACT

To provide a pattern formation method capable of forming a pattern by cleaning a liquid droplet ejection head without exerting an effect on a liquid droplet ejection operation, when the liquid droplet ejection head stored with a storage solution is used again, a pattern formation method of forming a film pattern by disposing liquid droplets of a functional solution on a substrate, includes: filling a passage including a liquid droplet ejection head to dispose the liquid droplets and a conduit to feed the functional solution to the liquid droplet ejection head with purified water; filling the passage with a solvent dissolving both a solvent contained in the functional solution and the purified water; filling the passage with the solvent contained in the functional solution; forming banks corresponding to the film pattern on the substrate; and disposing the liquid droplets into grooves between the banks with the liquid droplet ejection head.

### BACKGROUND OF THE INVENTION

1. Field of Invention

The present invention relates to a pattern formation method of forming a film pattern by disposing liquid droplets of a functional solution on a substrate, a pattern formation device thereof, a device manufacturing method, an electro-optical device, and an electronic apparatus.

2. Description of Related Art

In the related art, photolithography has been widely used as a method of manufacturing a device having fine wiring patterns (film patterns), such as a semiconductor integrated circuit. Recently, a device manufacturing method using a liquid droplet ejection method has attracted attention (see Japanese Unexamined Patent Application Publication No. 11-274671 and Japanese Unexamined Patent Application Publication No. 2000-216330). The liquid droplet ejection method has advantages in that waste of a functional solution is low and the amount and arrangement location of the functional solution disposed on the substrate is capable of being easily controlled. In the liquid droplet ejection method, a liquid droplet ejection head may be periodically cleaned in order to obtain a good ejection condition. Therefore, various cleaning methods have been proposed (see Japanese Unexamined Patent Application Publication No. 9-39260 and Japanese Unexamined Patent Application Publication No. 10-337882).

However, when a liquid droplet ejection apparatus used to manufacture a device is stored for a predetermined time, its liquid droplet ejection head is often filled with a water-soluble storage solution.

The water-soluble storage solution is used in consideration of problem of evaporation. In addition, the liquid droplet ejection head may not be filled with the storage solution but a functional solution (ink) used to manufacture the device. However, if the functional solution is easily dried or needs to be kept cold or frozen, it is not suitable for storage. So the liquid droplet ejection head must be stored by using a dedicated storage solution. In addition, when the stored liquid droplet ejection head is used or operated again, the water-soluble storage solution is removed and then the head is filled with the functional solution. However, if the functional solution and the storage solution are not easily soluble with each other, extracted solid materials may clog the passage for the functional solution, including the liquid droplet ejection head, so that there are disadvantages in that the liquid droplet ejection operation experiences problems and the functional solution may degenerate.

The present invention is contrived in consideration of the foregoing circumstances. Accordingly, the present invention provides a pattern formation method of forming a good pattern by smoothly filling the passage with a functional solution without causing problems during the liquid droplet ejection operation and without degenerating the functional solution, when the liquid droplet ejection head stored with a storage solution is used again, and a device manufacturing method. The present invention also provides an electro-optical device and an electronic apparatus manufactured by using a functional solution having a desired function and superior liquid droplet ejection operation.

### SUMMARY OF THE INVENTION

In order to address the problems, an aspect of the present invention provides a pattern formation method of forming a film pattern by disposing liquid droplets of a functional solution on a substrate. The method includes: a first replacement step of filling a passage, including a liquid droplet ejection head to dispose the liquid droplets and a conduit to feed the functional solution to the liquid droplet ejection head, with purified water; a second replacement step of filling the passage with a solvent dissolving both a solvent contained in the functional solution and the purified water; a third replacement step of filling the passage with the solvent contained in the functional solution; a bank formation step of forming banks corresponding to the film pattern on the substrate; and a material disposing step of disposing the liquid droplets into grooves between the banks with the liquid droplet ejection head. The pattern formation method may include a step of filling the passage with the functional solution after the third replacement step.

According to an aspect of the present invention, even in a case where a passage including a liquid droplet ejection head is stored by using a water-soluble storage solution, the passage is first filled with purified water. It is next filled with a predetermined solvent dissolving both of the purified water and a solvent contained in a functional solution. Finally, it is filled with the solvent contained in the functional solution. Therefore, it is possible to reduce or prevent problems, such as extraction of solid materials and degeneration of the functional solution, and to clean the passage and smoothly fill the passage with the functional solution.

An aspect of the present invention provides a pattern formation method of forming a film pattern by disposing liquid droplets of a functional solution on a substrate. The method includes: a first replacement step of filling a passage including a liquid droplet ejection head filled with a predetermined storage solution and a conduit to feed the functional solution to the liquid droplet ejection head with a first solvent dissolving the storage solution; a second replacement step of filling the passage with a second solvent dissolving both of the first solvent and a solvent contained in the functional solution; a third replacement step of filling the passage with the solvent contained in the functional solution; a bank formation step of forming banks corresponding to the film pattern on the substrate; and a material disposing step of disposing the liquid droplets into grooves between the banks with the liquid droplet ejection head. The pattern formation method may further include a step of filling the passage with the functional solution after the third replacement step.

According to an aspect of the present invention, even in a case where a passage including a liquid droplet ejection head is stored by using a predetermined storage solution rather than a water-soluble storage solution, the passage is first filled with a first solvent dissolving the storage solution. It is next filled with a second solvent dissolving both of the first solvent and a solvent contained in a functional solution. Finally it is filled with the solvent contained in the functional solution. Therefore, it is possible to reduce or prevent problems, such as extraction of solid materials and degeneration of the functional solution, and to clean the passage and smoothly fill the passage with the functional solution.

In the pattern formation method according to the present invention, the functional solution may exhibit electrical conductivity by thermal or optical treatments. According to an aspect of the present invention, it is possible to form a thin film pattern as a wiring pattern and to apply the method to various devices. In addition, by using a material for forming a light-emitting element, such as organic EL or RGB ink materials as well as an organic silver compound or conductive particles, it is possible to apply the method to the organic EL device or a liquid crystal display device having color filters.

In a device manufacturing method including a step of forming a film pattern on a substrate, the film pattern may be formed on the substrate by the aforementioned pattern formation methods.

According to an aspect of the present invention, it is possible to manufacture a device having a film pattern formed in a desired pattern shape by using a functional solution having a desired function without degeneration under a good liquid droplet ejection operation.

An aspect of the present invention provides an electro-optical device including a device manufactured by using the aforementioned device manufacturing method. In addition, an aspect of the present invention provides an electronic apparatus including the aforementioned electro-optical device. According to an aspect of the present invention, since a film pattern having a good conductivity formed under a good liquid droplet ejection operation by using a functional solution having a desired function is implemented, it is possible to provide an electro-optical device and an electronic apparatus having good performance.

Here, examples of the electro-optical device include, a plasma display device, a liquid crystal display device, and an organic electroluminescent display device.

Examples of an ejection method used for the liquid droplet ejection apparatus (inkjet apparatus) include a charging control method, a pressing vibration method, an electromechanical conversion method, an electro-thermal conversion method, an electrostatic suction method, and so on. In the charging control method, materials (a functional solution) are ejected from an ejection nozzle by providing charges to the materials with charging electrodes and controlling a flying direction of the materials with deflecting electrodes. In the pressing vibration method, the materials are ejected into a front end of the ejection nozzle by applying an ultra-high pressure of about 30 kg/cm² to the materials. When a control voltage is not applied, the materials go straight to be ejected from the ejection nozzle. However, when the control voltage is applied, the materials are spraying due to electrostatic repulsion between the materials, so that the materials cannot be ejected from the ejection nozzle. In the electro-mechanical conversion method using a property of a piezoelectric element that is deformed with applied electrical pulse signal, a pressure is applied to a space containing the materials through a flexible material by the deformation of the piezoelectric element, so that the materials can be pushed out from the space, thereby being ejected from the ejection nozzle. In the electro-thermal conversion method, the materials are rapidly vaporized by a heater provided to a space containing the materials to generate bubbles, so that the materials contained in the space can be ejected by the pressure of the bubbles.

In the electrostatic suction method, a small weak pressure is applied to a space containing the materials to generate a meniscus of the materials at an ejection nozzle. When an electro-static attraction is applied, the materials are ejected. A method using a change of viscosity of fluid due to electric field or a method of emitting discharge sparks may be utilized. The liquid droplet ejection method has advantages in that waste of used materials is small and a desired amount of the materials is capable of being disposed at a desired location. The weight of a droplet of the functional solution (a liquid material) ejected by the liquid droplet ejection method is in a range of, for example, 1 to 300 nanograms.

A liquid material containing a functional solution means a medium having a viscosity such that it can be ejected from an ejection nozzle of a liquid droplet ejection head (an inkjet head). The liquid material may be a water-based or oil-based material. A material having enough fluidity (viscosity) for the material to be ejected from the nozzle is satisfactory. If it is a fluid as a whole, the material having even solid materials mixed thereto is satisfactory. Materials contained in the liquid material may be materials dissolved by heating above their melting points as well as micro-particles dispersed in a solvent. The materials may be colorants, pigments, and other additive functional materials as well as a solvent. The substrate may include a flat substrate and a curved substrate. Hardness of its pattern formation plane is not necessarily high. The substrate may include a glass, a plastic, a metal, and other flexible material, such a film, a paper, a rubber, and so on.

### BRIEF DESCRIPTION OF THE DRAWINGS

FIG. 1 is a flowchart illustrating an exemplary embodiment of a cleaning process constituting a portion of a device manufacturing method according to an aspect of the present invention;

FIG. 2 is a flowchart illustrating an exemplary embodiment of a pattern formation method according to an aspect of the present invention;

FIG. 3 is a schematic illustrating an exemplary embodiment of a pattern formation device according to an aspect of the present invention;

FIG. 4 is a schematic illustrating states of cleaning operations performed by a pattern formation device according to an aspect of the present invention;

FIG. 5 is a flowchart illustrating another exemplary embodiment of a pattern formation method according to an aspect of the present invention;

FIG. 6 is a schematic illustrating an example of a pattern formation sequence according to an aspect of the presentinvention;

FIG. 7 is a schematic illustrating an example of a pattern formation sequence according to an aspect of the present invention;

FIG. 8 is a schematic illustrating an example of a plasma treatment device;

FIG. 9 is a schematic illustrating an example of an electro-optical device;

FIG. 10 is a schematic illustrating an example of an electro-optical device according to an aspect of the present invention;

FIG. 11 is a schematic illustrating an example of a device manufactured by a device manufacturing method according to an aspect of the present invention; and

FIG. 12 is view illustrating a specific example of an electronic apparatus according an aspect of to the present invention.

### DETAILED DESCRIPTION OF EXEMPLARY EMBODIMENTS

Pattern Formation Method

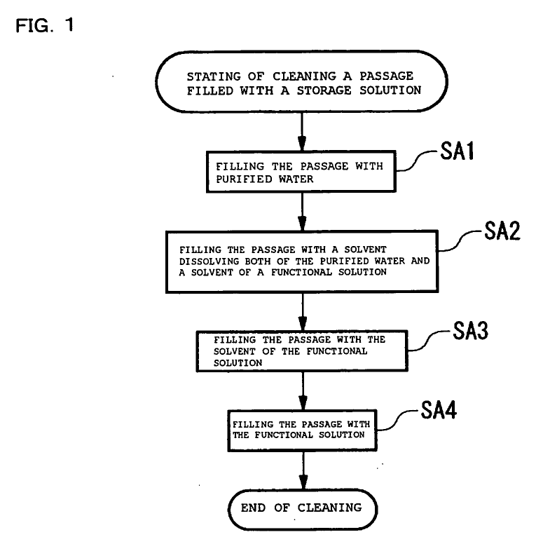

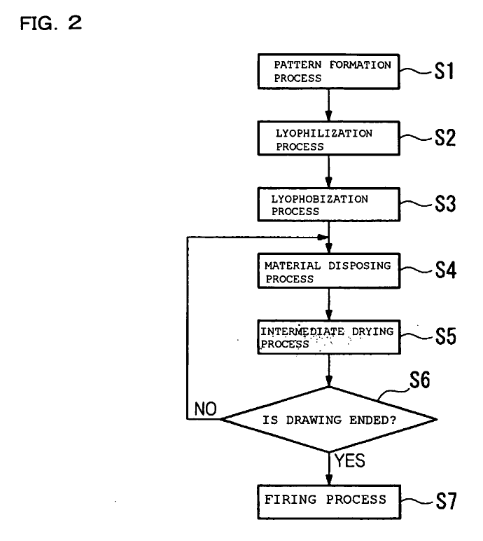

Now, a pattern formation method according to an aspect of the present invention will be described with reference to the accompanying drawings. FIGS. 1 and 2 are flowcharts illustrating an exemplary embodiment of a pattern formation method according to an aspect of the present invention. In the present exemplary embodiment, a case in which a conductive film wiring pattern is formed on a glass substrate is exemplified. A functional solution containing a material exhibiting electrical conductivity by a thermal treatment, and more specifically, silver micro-particles dispersed in tetradecane, serving as a dispersing medium, is used as a functional solution to form the conductive film wiring pattern.

The pattern formation method according to the present exemplary embodiment includes a cleaning process to clean a passage including a liquid droplet ejection head stored by using a predetermined storage solution and a conduit to feed a functional solution to the liquid droplet ejection head and filling the passage with the functional solution; and a pattern formation process to form a pattern by using the cleaned liquid droplet ejection head.

In FIG. 1, the cleaning process constituting a portion of the pattern formation method according to the present exemplary embodiment includes a first replacement process (Step SA1) to fill a passage including a liquid droplet ejection head filled with a water-soluble storage solution and a conduit to feed a functional solution to the liquid droplet ejection head with purified water; a second replacement process (Step SA2) to fill the passage with a solvent dissolving both of the purified water and a solvent contained in the functional solution used to manufacture a device; a third replacement process (Step SA3) to fill the passage with the solvent contained in the functional solution; and a fourth replacement process (Step SA4) to fill the passage with the functional solution.

As shown in FIG. 2, the pattern formation process includes a bank formation process (Step S1) to form banks corresponding to the film pattern on the substrate where liquid droplets of the functional solution are disposed; a lyophilization process (Step S2) to provide a lyophilic property to the bottom of each of grooves between the banks; a lyophobization process (Step S3) to provide a lyophobic property to the banks; a material disposing process (Step S4) to form (drawing) the film pattern by disposing a plurality of the liquid droplets of the functional solution in the grooves between the banks based on a liquid droplet ejection method; an intermediate drying process (Step S5) including optical and thermal treatments to remove at least a portion of liquid components of the functional solution disposed on the substrate; and a firing process (Step S7) to fire the substrate where a predetermined film pattern is formed. In addition, after the intermediate drying process, a process (Step S6) to determine whether or not a predetermined pattern drawing ends is performed. If the pattern drawing ends, the firing process proceeds. If the pattern drawing does not end, the material disposing process proceeds.

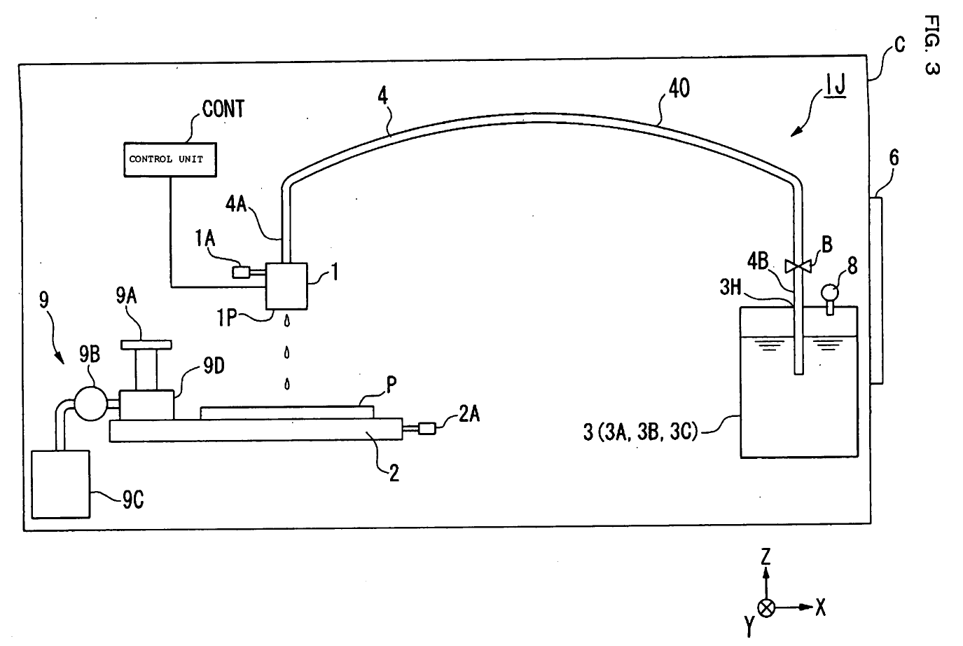

FIG. 3 is a schematic of the liquid droplet ejection apparatus constituting a portion of a pattern formation apparatus used for the pattern formation method according to an aspect of the present invention.

In FIG. 3, the liquid droplet ejection apparatus IJ includes a liquid droplet ejection head 1 to eject liquid droplets of the functional solution (ink); a stage 2 to support the substrate P where the liquid droplets of the ink ejected from the ejection head 1 is disposed; a tank 3 as a containing unit to contain the ink; and a conduit 40 connecting the ejection head 1 and the tank 3 and constituting a portion of a passage 4 through which the ink flows. The passage 4 through which the ink flows includes the conduit 40 and the ejection head 1. An operation of the liquid droplet ejection apparatus IJ, including an ejection operation of the ejection head 1, is controlled by a control unit CONT. All components of the liquid droplet ejection apparatus IJ including the ejection head 1, the conduit 40, and the tank 3 are accommodated in a chamber C. The temperature in the interior of the chamber C is controlled by a temperature adjustment unit 6. The interior of the chamber C may be set to an ambient atmosphere or an inert gas atmosphere of nitrogen gas, etc. The chamber C and the liquid droplet ejection apparatus IJ accommodated in the chamber C are installed within a clean room, so that cleanliness can be maintained in terms of particles or chemicals.

In the following description, a first direction on a horizontal plane is referred to as an X-axis direction. A second direction perpendicular to the first direction on the same horizontal plane is referred to as a Y-axis direction. A third direction perpendicular to the X-axis and Y-axis directions is referred to as a Z-axis direction. Rotational directions about X, Y, and Z axes are referred to as θX, θY, and θZ directions, respectively.

The liquid droplet ejection apparatus IJ forms a film made of materials contained in the ink by disposing liquid droplets of the ink on a surface of the substrate P. Here, the ink used in the present exemplary embodiment may include, for example, silver micro-particles dispersed in tetradecane, serving as a predetermined dispersing medium. The liquid droplet ejection apparatus IJ ejects the ink on the substrate P to form a wiring pattern (a conductive film pattern) of a device. The liquid droplet ejection apparatus IJ may manufacture a color filter by ejecting ink containing a color filter formation material for a liquid crystal display device, or it may manufacture a device, such as an organic EL device.

The ejection head 1 to quantitatively eject (dropping) the liquid droplets of the ink on the substrate P supported by the stage 2 includes a plurality of nozzles, to eject the liquid droplets, which are provided on a nozzle formation plane 1P of the ejection head 1. A head moving unit 1A to movably support the ejection head 1 is provided to the ejection head 1. The head moving unit 1A moves the ejection head 1 in the X, Y, and Z-axis directions and moves slightly in the θX, θY, and θZ directions. The temperature of the liquid droplets ejected from the ejection head 1 is controlled by a temperature adjustment unit (not shown) provided for the ejection head 1. The temperature adjustment unit also adjusts the viscosity of the liquid droplets at a desired value. The stage 2 to support the substrate P includes a suction hold unit (not shown) to vacuum-suction the substrate P. A stage moving unit 2A to movably support the stage 2 is provided for the stage 2. The stage moving unit 2A moves the stage 2 in the X, Y, and θZ directions.

The conduit 40 constructed with, for example, a synthetic resin tube is flexible. The passage 4 constructed with the conduit 40 has one end 4A connected to the ejection head 1 and the other end 4B connected to the tank 3. A valve B is provided at the other end 4B of the conduit 40. The opening and closing operations of the valve B are controlled by the control unit CONT. The control unit CONT controls the flow of the ink through the passage 4 by controlling the valve B. Specifically, the control unit CONT feeds or blocks the ink from the tank 3 to the ejection head 1 by controlling the valve B. Since the conduit 40 is constructed with a flexible material, the movement of the ejection head 1 by the head moving unit 1A is not interrupted.

For the tank 3 containing the ink, a radical elimination process is performed on the ink within the tank 3 in advance. The tank 3 includes an opening 3H into which the conduit 40 can be inserted. The inserting of the conduit 40 into the opening 3H results in substantially sealing the tank 3. A tank pressure adjustment unit 8 to adjust the pressure of the internal space of the tank 3 is provided for the tank 3. The operation of the tank pressure adjustment unit 8 is controlled by the control unit CONT. The control unit CONT controls the pressure of the interior of the tank 3 through the tank pressure adjustment unit 8. The pressure of the other end 4B of the passage 4 is controlled by adjusting the pressure of the tank 3. In the tank 3, although not shown in the drawings, a temperature adjustment unit to adjust the temperature of the ink within the tank and a stirring unit to stir the ink within the tank are attached to the tank 3. The temperature of the ink within the tank is adjusted by the temperature adjustment unit, so that the viscosity of the ink can be adjusted to a desired value.

A suction unit 9 capable of suctioning the ink in the ejection head 1 is provided at positions on the stage 2 excluding a position where the substrate P is mounted. The suction unit 9 includes a cap portion 9A which are closely connected to the nozzle formation plane 1P, where the nozzle is formed in the ejection head 1, to form a sealed space between the nozzle formation plane 1P and the cap portion; a lifter 9D to lift and support the cap portion 9A; a pump 9B to suction the ink in the nozzle of the ejection head 1 by suctioning gas within the sealed space; and an exhausted liquid receiving unit 9C to receive the ink suctioned from the ejection head 1. The position alignment of the nozzle formation plane 1P and the cap portion 9A in the X and Y directions is performed with relative movement of the ejection head 1 and the stage 2 based on the head moving unit 1A and the stage moving unit 2A. The nozzle formation plane 1P of the ejection head 1 and the cap portion 9A of the suction unit 9 are closely contacted to each other by lifting the cap portion 9A to the ejection head 1. A suction operation of the suction unit 9 is controlled by the control unit CONT. The control unit adjusts the pressure of the sealed space though the suction unit 9. The pressure at the one end 4A of the passage 4 is controlled by adjusting the pressure of the sealed space formed by the nozzle formation plane 1P and the cap portion 9A. The tank pressure adjustment unit 8 and the suction unit 9 constitute a pressure adjustment unit to adjust the pressure of the passage 4.

Next, a method of manufacturing a device by using the aforementioned liquid droplet ejection apparatus IJ will be described. In the exemplary embodiment, the passage 4 including the liquid droplet ejection head 1 to dispose the liquid droplets and the conduit 40 to feed the ink to the liquid droplet ejection head 1 is stored in a state where it is filled with an aqueous polyethylene glycol solution, a water-soluble storage solution. The passage 4 is subjected to a cleaning process before an ejection operation to manufacture a device.

In the cleaning process, first the other end 4B of the conduit 40 is connected to a tank 3A containing purified water (a first solvent). Herein, the tank 3A has the same construction as the tank 3 containing the ink, and it includes the tank pressure adjustment unit 8, etc. A radical elimination process is performed on the purified water within the tank 3A in advance. At this time, the purified water, that is, the first solvent, is capable of dissolving the aqueous polyethylene glycol solution, that is, the storage solution, and the purified water (the first solvent) and the storage solution are easily soluble with each other. When the tank 3A containing the purified water is connected to the other end 4B of the conduit 40, the control unit CONT sets a predetermined pressure difference between the one end 4A and the other end 4B of the passage 4 by using the suction unit 9 and the tank pressure adjustment unit 8 collectively serving as a pressure adjustment unit.

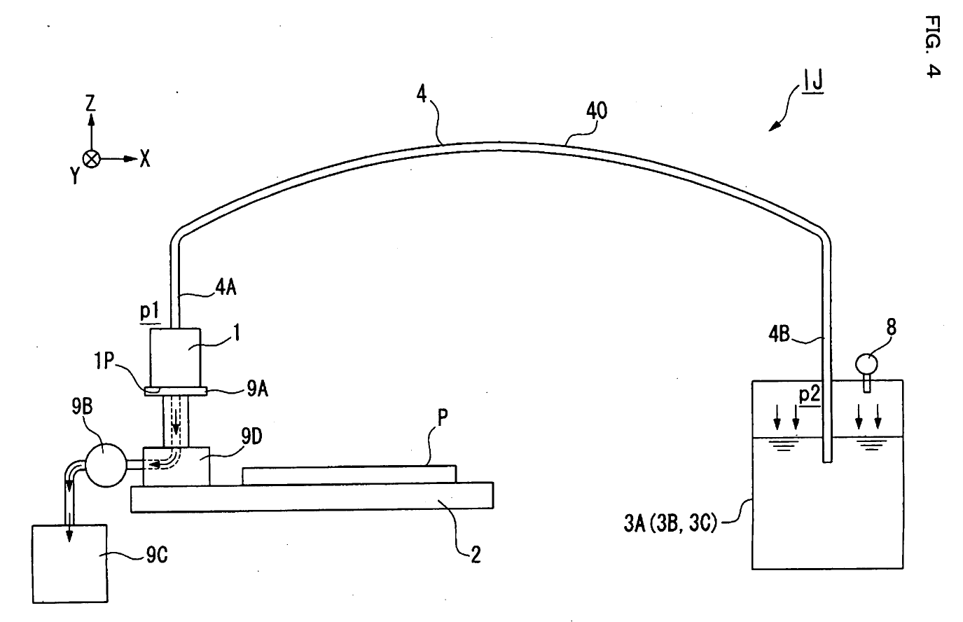

FIG. 4 is a schematic illustrating a state in which the pressure adjustment unit 8 and 9 perform pressure adjustment of the one end 4A and the other end 4B of the passage 4. As shown in FIG. 4, position alignment of the ejection head 1 and the cap portion 9A of the suction unit 9 in the X and Y axis directions are performed by the movement of the stage 2. The cap portion 9A and the nozzle formation plane 1P of the ejection head 1 are closely contacted to each other by the lifting of the cap portion 9A. Next, the pressure of the sealed space formed between the nozzle formation plane 1P of the ejection head 1 and the cap portion 9A are reduced by the operation of the pump 9B, so that the one end 4A of the passage 4 is set to the pressure p1. The pressure of the tank 3 is applied by the tank pressure adjustment unit 8, so that the other end 4B of the passage 4 is set to the pressure p2. The control unit CONT sets the predetermined pressure difference (p2−p1) between the one end 4A and the other end 4B of the passage 4 by adjusting a suction amount per unit time with the suction unit 9 (the pump 9B) while adjusting the pressure of the tank 3 with the tank pressure adjustment unit 8. Here, the control unit CONT sets the pressure difference (p2−p1) in the cleaning process to a higher value than the pressure difference in the ejection operation, a later process, to manufacture the device. In this state, the valve B opens, the suction unit 9 suctions the storage solution filling the passage 4 from the nozzle, and the suctioned storage solution is received by the exhausted solution receiving unit 9C. The purified water in the tank 3A fills the passage 4 by performing the pressurizing operation of the tank 3A and the suction operation of the suction unit 9. Then the passage 4 is filled with the purified water. The suctioned purified water (a cleaning solution) is received by the exhausted solution receiving unit 9C. The suction operation is performed for a predetermined time, so that the passage 4 is cleaned by the filling of the sufficient amount of purified water (Step SA1).

Since the one end 4A and the other end 4B of the passage 4 are set to a predetermined pressure difference, the cleaning solution (the purified water) flows through the passage 4 at a higher speed than that of the ejection operation, a later process, to manufacture the device. Therefore, the cleaning process can be sufficiently performed at a high speed.

When the passage 4 is filled with the purified water, the operations of the tank pressure adjustment unit 8 and the suction unit 9 are interrupted. After that, the conduit 40 and the tank 3A are disconnected from each other. The other end 4B of the conduit 40 is connected to the tank 3B containing isopropyl alcohol (a second solvent). The tank 3B also has the same construction as the tanks 3 and 3A. Herein, the second solvent, isopropyl alcohol, is a solvent capable of dissolving both of the first solvent, that is, the purified water, and the dispersing medium, tetradecane, contained in the ink. The second solvent is easily soluble in both of the purified water and the solvent contained in the ink. The second solvent may utilize isopropyl alcohol, that is, a polar solvent. A radical elimination process is performed on isopropyl alcohol within the tank 3B in advance. Similar to the process sequence described with reference to FIG. 4, when the tank 3B containing isopropyl alcohol is connected to the other end 4B of the conduit 40, the control unit CONT sets a predetermined pressure difference between the one end 4A and the other end 4B of the passage 4 by using the suction unit 9 and the tank pressure adjustment unit 8 collectively serving as a pressure adjustment unit. The passage 4 is filled with the second solvent, that is, isopropyl alcohol (Step SA2).

When the passage 4 is filled with the second solvent, the operations of the tank pressure adjustment unit 8 and the suction unit 9 are interrupted. After that, the conduit 40 and the tank 3B are disconnected from each other. The other end 4B of the conduit 40 is connected to the tank 3c containing tetradecane, serving as a dispersing medium contained in the ink. The tank 3C also has the same construction as the tanks 3, 3A, and 3B. Herein, tetradecane is a solvent capable of dissolving the second solvent, that is, isopropyl alcohol, and it is easily soluble in isopropyl alcohol. Tetradecane is a non-polar solvent. A radical elimination process is performed on the tetradecane within the tank 3C in advance. Similar to the process sequence described with reference to FIG. 4, when the tank 3C containing the tetradecane is connected to the other end 4B of the conduit 40, the control unit CONT sets a predetermined pressure difference between the one end 4A and the other end 4B of the passage 4 by using the suction unit 9 and the tank pressure adjustment unit 8 collectively serving as a pressure adjustment unit, and the passage 4 is filled with the dispersing medium contained in the ink, that is, tetradecane (Step SA3).

Although the dispersing medium of the ink of the exemplary embodiment is tetradecane, in a case where the ink includes plural kinds of solvents, the solvent filled in Step SA3 need not be completely identical to the plural kinds of the solvents contained in the ink. But any solvent among the plural kinds of solvents can be utilized. Here, the utilized arbitrary solvent may be a solvent (a main solvent) having the largest content among the plural kinds of solvent.

When the passage 4 is filled with tetradecane, the operations of the tank pressure adjustment unit 8 and the suction unit 9 are interrupted. After that, the conduit 40 and the tank 3C are disconnected from each other. The other end 4B of the conduit 40 is connected to the tank 3 containing the ink. A radical elimination process is performed on the ink within the tank 3 in advance. Similarly to the process sequence described with reference to FIG. 4, when the tank 3 containing the ink is connected to the other end 4B of the conduit 40, the control unit CONT sets a predetermined pressure difference between the one end 4A and the other end 4B of the passage 4 by using the suction unit 9 and the tank pressure adjustment unit 8 collectively serving as a pressure adjustment unit, and the passage 4 is filled with the ink (Step SA4).

At this time, the passage 4 may be filled with the ink while the temperature of the ink is adjusted by using the temperature adjustment unit 6 to adjust the temperature of the inside of the chamber C and a temperature adjustment unit (not shown) to adjust the temperature of the passage 4. For example, since the viscosity of the ink is reduced due to the heating of the ink, it is possible to smoothly perform the replacement process while reducing or preventing the generation of bubbles. The passage 4 including the conduit 40 may be filled with the ink while ultrasonic waves are applied. As a result, it is possible to exhaust the bubbles existing in the passage 4, such as bubbles attached on the inner wall of the conduit 40, and bubbles in the ink from the ejection head 1.

When the cleaning process ends, the control unit CONT stops the suction operation of the suction unit 9 and the pressurizing operation of the tank pressure adjustment unit 8 to pressure the tank 3.

The stage 2 moves to locate the substrate P under the ejection head 1 and starts an ejection operation to manufacture the device. Here, the control unit CONT sets the pressure difference between the one end 4A and the other end 4B of the passage 4 to a lower value than that in the cleaning process.

The temperature adjustment unit 6 also adjusts the temperature of the chamber C to an optimal value to manufacture the device. Next, a liquid droplet ejection operation to manufacture the device is performed.

In the exemplary embodiment, since a water-soluble polyethylene glycol is used as a storage solution, the first replacement process SA1 is constructed with a cleaning process using the purified water. However, the cleaning process according to an aspect of the present invention may be used for a case where the storage solution is not an aqueous solution. In this case, the solvent dissolving the storage solution may be used as the first solvent used in the first replacement process.

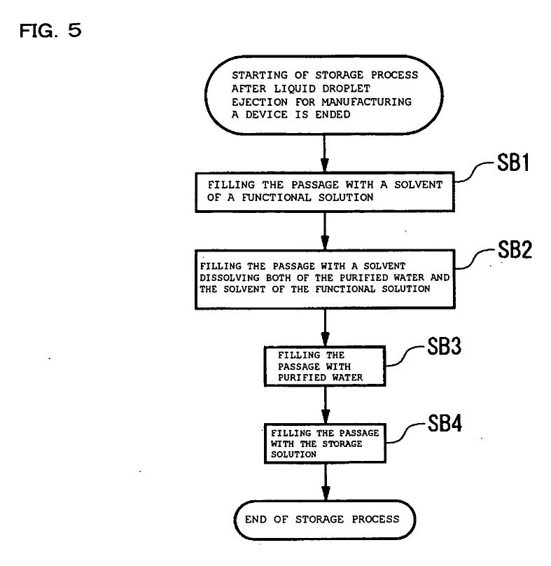

The cleaning process from the state of storage to the ejection-available state of the liquid droplets of the ink has been described. Now, a process sequence from the completion of the ejection operation of the liquid droplets of the ink to the state of storage of the passage 4, including the liquid droplet ejection head 1 and the conduit 40, will be described with reference to FIG. 5.

When the liquid droplet ejection operation to manufacture the device ends, the starting of the storage process is commanded. First, the conduit 40 and the tank 3 containing the ink are disconnected from each other. The tank 3C containing the dispersing medium, that is, tetradecane, contained in the ink is connected to the other end 4B of the conduit 40. When the tank 3c containing tetradecane is connected to the other end 4B of the conduit 40, the control unit CONT sets a predetermined pressure difference between the one end 4A and the other end 4B of the passage 4 by using the suction unit 9 and the tank pressure adjustment unit 8, as the pressure adjustment unit, and the passage 4 is filled with the tetradecane (Step SB1).

When the passage 4 is filled with the tetradecane, the operations of the tank pressure adjustment unit 8 and the suction unit 9 are interrupted. After that, the conduit 40 and the tank 3C are disconnected from each other. The other end 4B of the conduit 40 is connected to the tank 3B containing isopropyl alcohol (the second solvent). When the tank 3B containing isopropyl alcohol is connected to the other end 4B of the conduit 40, the control unit CONT sets a predetermined pressure difference between the one end 4A and the other end 4B of the passage 4 by using the suction unit 9 and the tank pressure adjustment unit 8, as the pressure adjustment unit, and the passage 4 is filled with the second solvent, that is, isopropyl alcohol (Step SB2).

When the passage 4 is filled with the second solvent, the operations of the tank pressure adjustment unit 8 and the suction unit 9 are interrupted. After that, the conduit 40 and the tank 3B are disconnected from each other. The other end 4B of the conduit 40 is connected to the tank 3A containing the purified water. When the tank 3A containing the purified water is connected to the other end 4B of the conduit 40, the control unit CONT sets a predetermined pressure difference between the one end 4A and the other end 4B of the passage 4 by using the suction unit 9 and the tank pressure adjustment unit 8, as the pressure adjustment unit, and the passage 4 is filled with the purified water (Step SB3).

When the passage 4 is filled with the purified water, the operations of the tank pressure adjustment unit 8 and the suction unit 9 are interrupted. After that, the conduit 40 and the tank 3A are disconnected from each other. The other end 4B of the conduit 40 is connected to the tank containing the water-soluble storage solution, that is, the aqueous polyethylene glycol solution. When the tank containing the storage solution is connected to the other end 4B of the conduit 40, the control unit CONT sets a predetermined pressure difference between the one end 4A and the other end 4B of the passage 4 by using the suction unit 9 and the tank pressure adjustment unit 8, as the pressure adjustment unit, and the passage 4 is filled with the storage solution (Step SB4). As a result, the passage 4 is filled with the storage solution, and the storage process ends. As described above, in the storage process, the cleaning solutions may be used in the reverse order of those of the cleaning process.

### EXAMPLE 1

In each of the plurality of replacement processes, the passage 4 stored by using a storage solution, that is, a 1% aqueous polyethylene glycol, is filled and cleaned with the following solvents (cleaning solutions):

First Replacement Process: purified water

Second Replacement Process: isopropyl alcohol

Third Replacement Process: tetradecane

After that, the ink (a functional solution) including silver micro-particles dispersed in tetradecane, serving as a dispersing medium, is used as a functional solution to form a conductive wiring pattern. Since solid materials are not extracted from the passage 4, it is possible to perform a good liquid droplet ejection operation.

### EXAMPLE 2

In each of the plurality of replacement processes, the passage 4 stored by using a 1% aqueous polyethylene glycol as a storage solution is filled and cleaned with the following solvents (cleaning solutions):

First Replacement Process: purified water

Second Replacement Process: ethyl alcohol

Third Replacement Process: ethylene glycol

After that, a pattern formation operation is performed by using the ink (a functional solution) including an organic silver compound having diethylene glycol as a solvent. Since solid materials are not extracted from the passage 4, it is possible to perform a good liquid droplet ejection operation.

Now, the pattern formation process to manufacture a device will be described.

Bank Formation Process

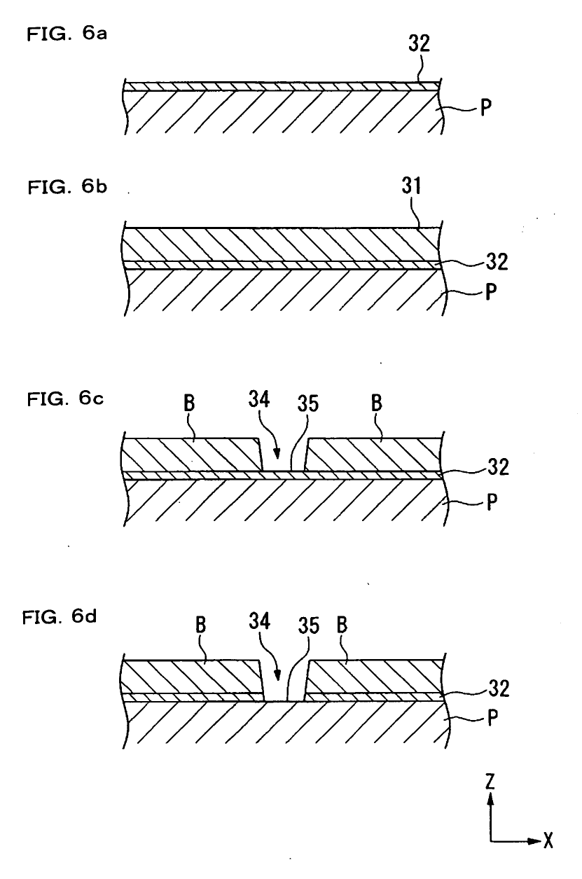

Firstly, as shown in FIG. 6a, an HMDS treatment, a surface property modification treatment is performed on the substrate P. The HMDS treatment is a method of applying hexamethyl disilazane ((CH₃)₃SiNHSi(CH₃)₃) in the form of vapor. As a result, an HMDS layer 32, serving as a close-contact layer to enhance the degree of contact between the banks and the substrate P is formed on the substrate P. The banks function as partition members, and the formation of the banks is performed by using a photolithography method, a printing method, and so on. For example, in a case where the photolithography method being used, shown in FIG. 6b, an organic material 31, that is, a bank formation material is coated on the HMDS layer 32 of the substrate p to match with a height of the bank by using a method out of spin coat, spray coat, roll coat, die coat, deep coat methods, and a resist layer is coated thereon. Next, a masking process is performed in accordance with a shape of the banks (wiring pattern), and resist-exposing and developing processes are performed, thereby leaving resist in accordance with the shape of the banks. Finally, the organic material 31 in regions excluding the resist are removed by using an etching process. The banks may be formed to have two layers or more, of which lower and upper layers are made of inorganic and organic materials, respectively. As a result, as shown in FIG. 6c, banks B and B protrude to surround prearrangement regions to form a wiring pattern. The organic material constituting the banks may be a material having a lyophobic property to the functional solution (a liquid material) or an insulating organic material capable of exhibiting a lyophobic property by a plasma treatment later described, having a good degree of contact with a base substrate, and being easily patterned by a photolithography process. For example, a polymer material, such as an acryl resin, a polyimide resin, an olefin resin, a phenol resin, and a melamine resin may be utilized.

When the banks B and B are formed on the substrate p, a hydrofluoric acid treatment is performed. The hydrofluoric acid treatment is a treatment to remove the HMDS layer 32 between the banks B and B by performing an etching process using, for example, a 2.5% aqueous hydrofluoric acid solution. In the hydrofluoric acid treatment, the banks B and B function as marks, and the HMDS layer 32, that is, an organic material at a bottom 35 of each of the grooves 34 formed between the banks B and B is removed. As a result, HMDS, as a residue, is removed as shown in FIG. 6d.

Lyophilization Process

Next, a lyophilization process to provide a lyophilic property to the bottom 35 of each of the grooves 34 between the banks is performed. The lyophilization process may be selected among a ultra-violet (UV) irradiation treatment to provide the lyophilic property by irradiating UV light and an O₂ plasma treatment using oxygen as a process gas at an atmospheric ambience may be selected. In the exemplary embodiment, the O₂ plasma treatment is performed.

In the O₂ plasma treatment, oxygen in a plasma state from plasma discharging electrodes is irradiated on the substrate. The conditions of the O₂ plasma treatment are, for example, as follows. The plasma power is in a range of 50 to 1000 W. The flow rate of the oxygen gas is in a range of 50 to 100 mL/min. The relative moving speed of the substrate with respect to the plasma discharging electrode is in a range of 0.5 to 10 mm/sec. The temperature of the substrate is in a range of 70 to 90° C. In case of the substrate being made of glass, although its surface has a lyophilic property to the functional solution, the lyophilic property of the surface (the bottom 35) of the substrate P exposed between the banks B and B can further increase by performing the O₂ plasma treatment or the UV irradiation treatment like the exemplary embodiment. Here, the O₂ plasma treatment or the UV irradiation treatment may be performed with a contact angle of the bottom 35 between the banks with respect to the functional solution being below 15 degrees or less.

The O₂ plasma treatment or the UV irradiation treatment has a function of removing the HMDS constituting a portion of the residues existing at the bottom 35. For this reason, even in a case where the organic residues (HMDS) of the bottom 35 between the banks B and B are not completely removed by the aforementioned hydrofluoric acid treatment, the residues can be removed by performing the O₂ plasma treatment or the UV irradiation treatment. Although the hydrofluoric acid treatment is performed as a portion of a residue disposal process, since the resides of the bottom 35 between the banks can be sufficiently removed by the O₂ plasma treatment or the UV irradiation treatment, the hydrofluoric acid treatment may not be performed. Although it is described that the residue disposal process seems to have to be performed by a single one of the O₂ plasma treatment and the UV irradiation treatment, the residue disposal process may be performed by a combination of the O₂ plasma treatment and the UV irradiation treatment.

Lyophobization Process

Subsequently, a lyophobization process to provide a lyophobic property to the surface of the bank B is performed. The lyophobization process may employ a plasma treatment method (CF₄ plasma treatment method) using carbon tetrafluoride (tetrafluoro methane) as a process gas at an atmospheric ambience. The conditions of the CF₄ plasma treatment method are, for example, as follows. The plasma power is in a range of 100 to 800 W. The flow rate of the carbon tetrafluoride gas is in a range of 50 to 100 mL/min. The relative moving speed of the substrate with respect to the plasma discharging electrode is in a range of 0.5 to 1020 mm/sec. The temperature of the substrate is in a range of 70 to 90° C. The process gas is not limited to the carbon tetrafluoride but it may employ other fluorocarbon gases. By performing the lyophobization process, fluoric radicals are induced into a resin constituting the banks B and B, so that a highly lyophobic property can be provided. Although the O₂ plasma treatment as the aforementioned lyophilization process may be performed before the formation of the bank B, since the acryl resin or the polyimide resin subjected to a pretreatment of the O₂ plasma treatment can be easily lyophobizated (fluorinated), the O₂ plasma treatment may be performed after the formation of the bank B.

Although the lyophobization process on the banks B and B has a few effects on the exposed portion of the substrate P between the banks subjected to a lyophilization process in advance, in a particular case of the substrate P being made of glass, since the fluoric radicals induced due to the lyophobization process do not occur, the lyophilic property, that is, wettability, of the substrate P is not substantially deteriorated. If the banks B and B are made of a material having a lyophobic property (for example, a resin material having a fluoric radical), the lyophobization process on the banks B and B may be omitted.

Material Disposing Process

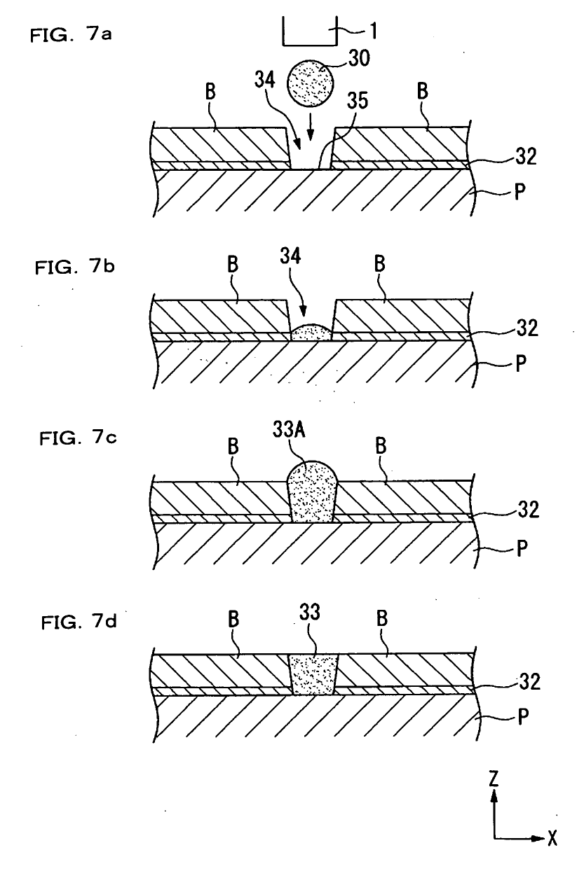

Now, a material disposing process of the exemplary embodiment will be described. The material disposing process is a process to form a film pattern (a wiring pattern) having a shape of line on the substrate P by ejecting the liquid droplets 30 of the functional solution containing a wiring pattern formation material from the liquid droplet ejection head 1 of the liquid droplet ejection apparatus to dispose the liquid droplets in the grooves 34 between the banks B and B as shown in FIGS. 7e and 7f. In the exemplary embodiment, the functional solution includes an organic silver compound dispersed in tetradecane, serving as a dispersing medium.

In the material disposing process, the liquid droplets 30 ejected from the liquid droplet ejection head 1 are disposed in the groove 34 between the banks B and B. At this time, since the regions to form a wiring pattern formation scheduling area (that is, the grooves 34) where the liquid droplets are ejected are surrounded with the banks B and B, it is possible to reduce or prevent the liquid droplets from spreading beyond the predetermined locations. Since the lyophobic property is provided to the banks B and B, even though a portion of the ejected liquid droplets are mounted on the bank B, the ejected liquid droplets are repulsed from the bank B due to the lyophobic property of the surface of the banks, so that the liquid droplets drop into the grooves 34 between the banks. Since the lyophilic property is provided to the bottom 35 of the grooves 34 where the substrate P is exposed, the liquid droplets ejected on the bottom 35 can be more easily spreading, so that the function solution can be uniformly disposed at the predetermined locations.

The conditions of the liquid droplet ejection may be selected as follows. The weight of the ink is 4 ng/dot. The ink flow rate (the ejection speed) is in a range of 5 to 7 m/sec. With respect to the ejection ambiance of the liquid droplets, the temperature and the humidity may be set to 60° C. or less and 80% or less, respectively. As a result, it is possible to perform a stable liquid droplet ejection without clogging of the ejection nozzle of the liquid droplet ejection head 1.

Intermediate Drying Process

After the liquid droplets are ejected on the substrate P, a drying process is performed in order to remove the dispersing media and ensure thickness of the film, if necessary. The drying process may employ, for example, a lamp annealing process as well as a general process using hot plates, electric furnaces, or the like, to heat the substrate P. A light source used for the lamp annealing process includes, but is not limited to, an infrared lamp, a xenon lamp, a YAG laser, an argon laser, a carbon dioxide laser, an excimer laser using XeF, XeCl, XeBr, KrF, KrCl, ArF, ArCl, etc. Although the powers of these lasers are generally in a range of 10 to 5000 W, the laser of the present exemplary embodiment satisfactorily utilizes the power of 100 to 1000 W. A plurality of liquid droplets of the functional solution are stacked to form a plurality of films by repetition of the intermediate drying process and the material disposing process, as shown in FIG. 7g, so that the wiring pattern (the film pattern) 33A having a large thickness can be formed.

Firing Process

The conductive material, for example, the organic silver compound, after the ejection process needs to be subjected to a thermal treatment to remove an organic component of the organic silver compound and retain the silver particles in order to obtain its conductivity.

For this reason, a thermal treatment and/or a optical treatment are performed on the substrate after the ejection process. Although the thermal treatment and/or the optical treatment are generally performed at the atmosphere, it may be performed at an inert gas ambiance using nitrogen, argon, helium, etc., if necessary. The process temperature of the thermal treatment and/or the optical treatment is suitably selected in consideration of a boiling point (a vapor pressure) of a dispersing medium, types or pressure of ambient gas, a dispersibility of micro-particles, an organic silver compound, thermal behaviors, such as an oxidation property, presence or absence of a coating material, and an amount of the coating material, heat-resistant temperature of a base material, etc. For example, a firing process is necessarily performed at about 200° C. to remove organic materials of the organic silver compound. In case of the substrate being made of plastic, the firing process may be performed at a temperature of the room temperature to 100° C. According to the foregoing process, the conductive materials (the organic silver compound) after the ejection process are transformed into a conductive film (the wiring pattern) 33 due to the remaining silver particles, as shown in FIG. 7h.

The banks B and B existing on the substrate P after the firing process may be removed by using an ashing peeling process. The ashing process may employ a plasma ashing or ozone ashing process. The plasma ashing process is a process to peel and remove the bank by reacting the bank with a gas, such as plasma oxygen gas to vaporize the bank. Since the bank is a solid material including carbon, oxygen, and hydrogen, the bank chemically reacts with the oxygen plasma to become CO₂, H₂O, and O₂, so that it can be peeled off as gases. The basic principle of the ozone ashing process is the same as that of the plasma ashing process. In the ozone ashing process, O₃ (ozone) is transformed into O⁺ (an oxygen radical) of a reactive gas and the O⁺ is reacted with the bank. The bank reacting with the O⁺ becomes CO₂, H₂O, and O₂, so that it can be peeled off as gases. The banks are removed from the substrate P by performing the ashing peeling process on the substrate P.

In the aforementioned exemplary embodiments, the substrate used for the conductive film wiring may utilize glass, quartz glass, Si wafer, a plastic film, a metal plate, or others various materials. It includes these various material substrates on which a semiconductor film, a metal film, a dielectric film, an organic films, etc. are formed as a base layer.

Although the functional solution used for the conductive film wiring utilizes a conductive material including the organic silver compound dissolved in a solvent in the aforementioned exemplary embodiment, it is possible to utilize the dispersing solution in which the conductive micro-particles are dispersed, and it may be a water-based or oil-based material. The conductive micro-particles may be a conductive polymer or a superconductive micro-particle as well as metal containing any one of gold, silver, copper, palladium, and nickel. These conductive micro-particles of which the surfaces are coated with organic materials may be used in order to enhance dispersibility.

The diameter of the conductive micro-particle may be in a range of 5 nm to 0.1 μm. If the diameter is larger than 0.1 μm, the nozzle of the liquid droplet ejection head may be disadvantageously clogged. If the diameter is smaller than 5 nm, the volume ratio of the coating with respect to the conductive micro-particle increases, so that the ratio of the organic materials with respect to the obtained film is too excessive.

The vapor pressure of the dispersing medium of a liquid containing the conductive micro-particles at the room temperature may be in a range of 0.001 to 200 mmHg (about 0.133 to about 26600 Pa). If the vapor pressure is higher than 200 mmHg, the dispersing medium after being ejected is too rapidly vaporized, and it is difficult to form a good film. The vapor pressure of the dispersing medium may be in a range of 0.001 mmHg to 50 mmHg (about 0.133 to 6650 Pa). If the vapor pressure is higher than 50 mmHg, in case of the liquid droplets being ejected with an inkjet method, the nozzle clogging due to drying may easily occur. In a case where the vapor pressure of the dispersing medium at the room temperature is lower than the 0.001 mmHg, the drying rate is too slow and thus the dispersing medium may disadvantageously remain, so that it is difficult to obtain a good conductive film after the thermal and optical treatments in the following processes.

The dispersing medium capable of dispersing the aforementioned conductive micro-particles may be, but is not limited to, a material that does not generate agglutination. Although the dispersing medium in the present exemplary embodiment utilizes tetradecane, the dispersing medium includes, for example, water, an alcohol, such as methanol, ethanol, propanol, butanol, etc., a hydrocarbon compound such as n-heptane, n-octane, decane, toluene, xylene, cymene, durene, indene, dipentene, tetrahydro naphthalene, decahydro naphthalene, cyclo hexylene, etc., an ether compound, such as ethylene glycol dimethly ether, ethylene glycol diethly ether, ethylene glycol methly ethyl ether, diethylene glycol dimethly ether, diethylene glycol methly ethyl ether, 1,2-dimethoxy ethane, bis(2-methoxy ethyl)ether, p-dioxane, etc., and a polar compound, such as propylene carbonate, λ-butyrolactone, N-methyl-2-pyrolidone, dimethyl formamide, dimethyl sulphaoxide, cyclo hexanone, etc. Among them, in terms of dispersibiltiy of the micro-particles, stability of the dispersing solution, easy applicability to the liquid droplet ejection method, the water, the alcohol compound, the hydrocarbonate compound, and the ether compound are preferable. A preferred dispersing media are the water and the hydrocarbonate compound. Theses dispersing media may be used individually or in a combination of two kinds or more.

In case of the conductive micro-particles being dispersed in a dispersing medium, the concentration of the dispersoid is in a range of 1 to 80 percent by weight. It may be advantageously adjusted in accordance with the thickness of a desired conductive film. If the concentration is above 80 percent by weight, it is difficult to generate cohesion, and it is difficult to obtain a uniform film.

The surface tension of the dispersing solution of the conductive micro-particles may be in a range of 0.02 N/m to 0.07 N/n. When a liquid material is ejected with the liquid droplet ejection method, if the surface tension is less than 0.02 N/m, since the wettability of the liquid material with respect to the nozzle plane increases, the flight deviation can disadvantageously occur. If the surface tension is more than 0.07 N/m, since the meniscus shape at the front end of the nozzle is not stabilized, it is difficult to control ejection amount and ejection timing.

In order to adjust the surface tension, an infinitesimal amount of surface tension control agents, such as fluorine, silicon, and nonion control agents, is added to the dispersing solution to an extent that the control agents cannot deteriorate the contact angle with respect to the substrate. The nonion surface tension control agents enhance wettability of the liquid with respect to the substrate to enhance the leveling of the film and to reduce or prevent the fine unevenness of the film from being generated. The dispersing solution may include an organic compound, such as alcohol, ether, ester, ketone, etc., if necessary.

The viscosity of the dispersing solution may be in a range of 1 to 50 mPa·s. In case of the liquid droplets as the liquid material being ejected with the liquid droplet ejection method, if the viscosity is smaller than 1 mPa·S, the peripheral portion of the nozzle can be easily contaminated due to effusion of the liquid material. If the viscosity is larger than 50 mPa·S, the frequency of the clogging of the nozzle opening increases so that it is difficult to smoothly eject the liquid droplets.

Plasma Treatment Apparatus

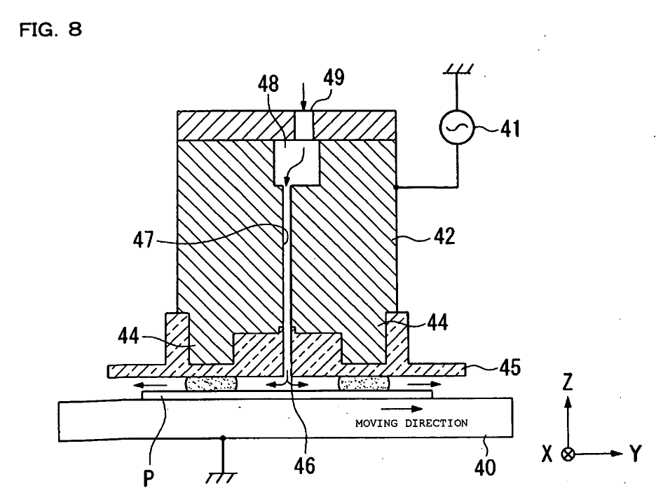

FIG. 8 is a schematic illustrating an example of a plasma treatment apparatus used for the aforementioned lyophilization treatment (the O₂ plasma treatment) or the lyophobization treatment (CF₄ plasma treatment). The plasma treatment apparatus illustrated in FIG. 8, includes an electrode 42 connected to an alternating current power source 41; and a specimen table 40 functioning as a ground electrode. The specimen table 40 to support the substrate P, that is, a specimen, is movably provided in Y-axial direction. On a lower surface of the electrode 42, two discharge generation portions 44 and 44, extending in X-axial direction perpendicular to the moving direction and being parallel to each other, are provided to protrude; and a dielectric member 45 surrounding the discharge generation portions 44 are provided. The dielectric member 45 has a function of reducing or preventing an abnormal discharge of the discharge generation portions 44. The lower surface of the electrode 42 including the dielectric member 45 has a substantially planar shape, and a small space (a discharge gap) is defined among the discharge generation portions 44, the dielectric member 45, and the substrate P. A thin, long gas effusion opening 46, constituting a portion of a process gas feeding portion, extends in X-axial direction at the center of the electrode 42. The gas effusion opening 46 is connected to a gas introduction opening 49 through a gas passage 47 and an intermediate chamber 48 within the electrode. A predetermined gas including a process gas sprayed from the gas effusion opening 46 through the gas passage 47 is divided and flown into two directions within the space, that is, the front and rear directions of the moving direction (Y-axial direction). The gas is exhausted from the font and rear ends of the dielectric member 45. At the same time, a predetermined voltage is applied from the power source 41 to the electrode 42, and gas discharge generates between each of the discharge generation portions 44 and 44 and the specimen table 40. Next, excited active species of the predetermined gas are generated by the plasma generated by the gas discharge. The overall surface of the substrate P passing though the discharge space are continuously subjected to the process. In the exemplary embodiment, the predetermined gas is a mixture of a process gas, such as oxygen (O₂) and carbon tetrafluoride (CF₄) and an inert gas, such as rare gas including helium (He) and argon (Ar) and nitrogen (N₂) used to easily start and stably maintain the discharge under about the atmospheric pressure. In particular, in case of oxygen being used as the process gas, the aforementioned lyophilization and the removal of the organic residues are performed. In case of carbon tetrafluoride being used as the process gas, the lyophobization is performed. A work function of the electrode can be adjusted by performing the O₂ plasma treatment on, for example, an electrode in an organic EL apparatus.

Electro-Optical Device

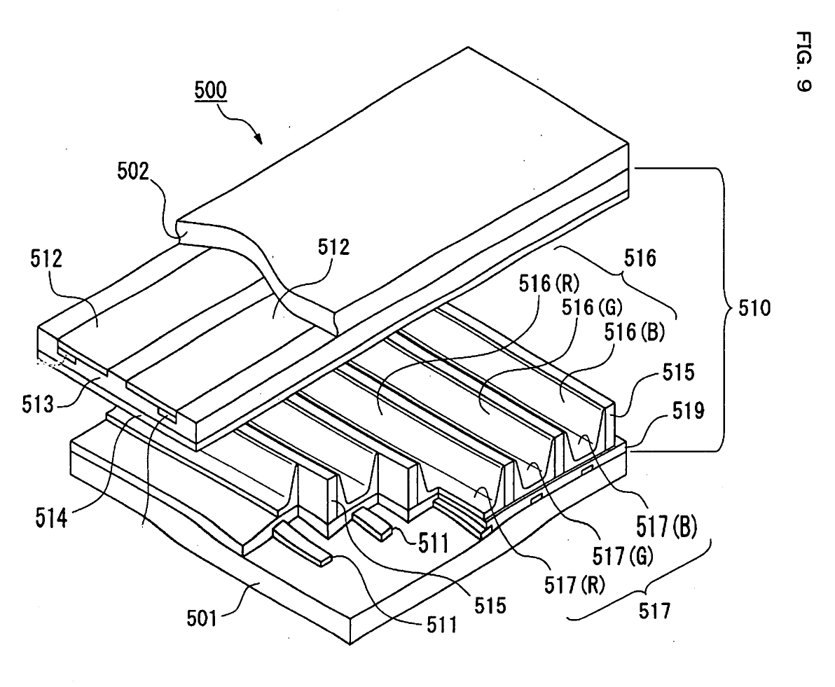

Now, a plasma display apparatus as an example of an electro-optical device according to an aspect of the present invention will be described. FIG. 9 is an exploded perspective view illustrating the plasma display apparatus 500 of an exemplary embodiment. The plasma display apparatus 500 includes substrates 501 and 502 facing each other and a discharge display plate 510 interposed therebetween. The discharge display plate 510 includes a plurality of discharge cells 516. Three discharge cells 516 of red, green, and blue discharge cells 516(R), 516(G), and 516(B) among the plurality of discharge cells 516 constitute a single pixel.

Address electrodes 511 are provided in stripes in a predetermined interval on an upper surface of the substrate 501. A dielectric layer 519 is provided to cover the address electrodes 511 and the upper surface of the substrate 501. On the dielectric layer 519, partition walls 515 are disposed between the address electrodes 511 and 511 to extend along with the respective address electrodes 511. The partition walls 515 include partition walls adjacent to left and right sides of the address electrodes 511 in the width direction thereof and partition walls extending in a direction perpendicular to the address electrodes 511. The discharge cells 516 are provided to correspond to rectangular spaces partitioned by the partition walls 515. The fluorescent layers 517 are provided inside the rectangular spaces partitioned by the partition walls 515. Each of the fluorescent layers 517 emits a fluorescent ray having one of red, green, and blue colors. Red, green, and blue fluorescent materials 517(R), 517(G), and 517(B) are provided to the respective bottoms of the red, green, and blue discharge cells 516(R), 516(G), and 516(B).

A plurality of display electrodes 512 are provided on the substrate 502 in stripes in a predetermined interval in a direction perpendicular to the aforementioned address electrodes 511. A dielectric layer 513 and a protective film 514 made of MgO, etc., are provided to cover these electrodes 512. The substrates 501 and 502 are coupled to each other so that the address electrodes 511 and the display electrodes 512 are perpendicular to each other. The address electrodes 511 and the display electrodes 512 are connected to an AC voltage source (not shown). The electrical turn on of each of the electrodes allows the fluorescent materials 517 in the display discharge portion 510 to excite and emit rays of light, so that color display can be implemented.

In the exemplary embodiment, the address electrodes 511 and the display electrodes 512 are formed based on the pattern formation method of an aspect of the present invention. In the exemplary embodiment, the banks B are removed with the ashing process.

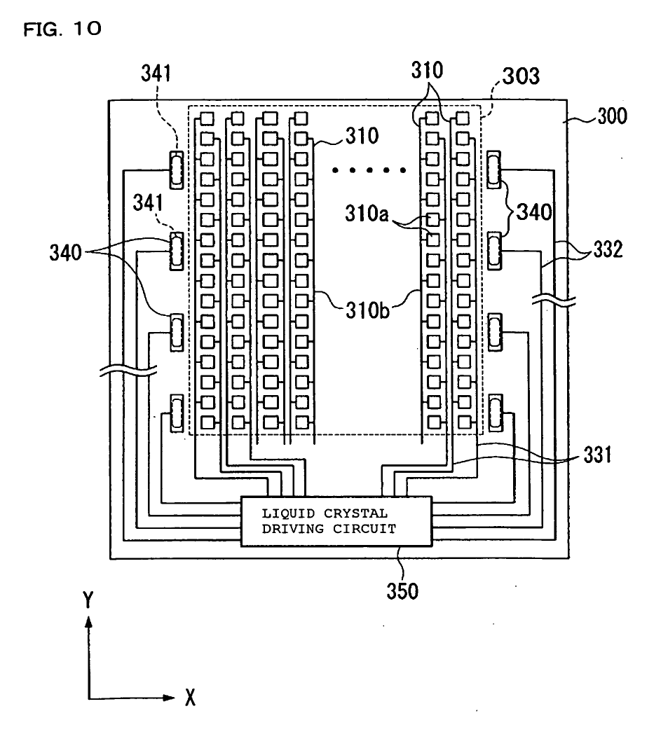

Now, a liquid crystal apparatus as another example of the electro-optical device of an aspect of the present invention will be described. FIG. 10 is a schematic illustrating a planar layout of signal electrodes and the like on a first substrate of the liquid crystal apparatus according to an aspect of the present invention. The liquid crystal apparatus according to an aspect of the present invention are schematically constructed with the first substrate, a second substrate (not shown) on which scanning electrodes and the like are provided, and liquid crystals (not shown) interposed between the first and second substrate.

As shown in FIG. 10, a plurality of signal electrodes 310 are provided in a multiple-matrix shape on a pixel region 303 on the first substrate 300. In particular, each of the signal electrodes 310, constructed with a plurality of pixel electrodes portions 310a that is provided to correspond to each of the pixels and a plurality of signal wiring portions 310b that connect the pixel electrode portions in a matrix, extends in Y direction. Reference numeral 350 indicates a liquid crystal driving circuit having a single chip structure. The liquid crystal driving circuit 350 is connected to the one ends (lower side of the drawing) of the signal wiring portions 310b through first surrounding wirings 331. Reference numeral 340 indicates up-down interconnection terminals. The up-down interconnection terminals 340 are connected to terminals (not shown) provided on the second substrate through up-down interconnection materials 341. The up-down interconnection terminals 340 are connected to the liquid crystal driving circuit 350 through second surrounding wirings 332.

In the exemplary embodiment, the signal wiring portions 310b, the first surrounding wirings 331, and the second surrounding wirings 332, which are provided on the first substrate 300, are formed based on the pattern formation method of an aspect of the present invention. Since the method can be adapted to manufacturing a large liquid crystal substrate, the wiring materials can be efficiently used so that cost can be reduced. The devices to which the present invention can be adapted is not limited to these electro-optical devices. But it can be adapted to, for example, manufacturing a circuit board where conductive film wiring is formed, semiconductor mounting wiring, and other devices.

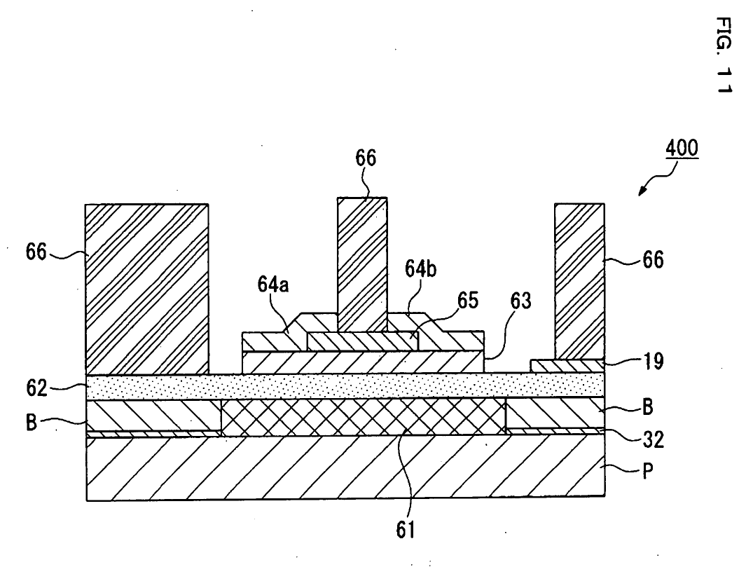

FIG. 11 is a schematic illustrating a thin film transistor 400 as a switching element provided to each of the pixels of the liquid crystal display device. Gate wiring 61 is formed between banks B and B on the substrate P with the pattern formation method of the aforementioned exemplary embodiment. A semiconductor layer 63 made of amorphous silicon (a-Si) layer is stacked on the gate wiring 61 through a gate insulating film 62 made of siNx. A region of the semiconductor layer 63 facing the gate wiring portion becomes a channel region. Contact layers 64a and 64b made of, for example, n+ type a-Si layer are stacked on the semiconductor layer 63 in order to obtain ohmic contact. An insulating etch stop film 65 made of SiNx is provided on the semiconductor layer 63 at a central portion of the channel region in order to protect the channel. The pattern shown in the drawing is obtained by performing a deposition (CVD) process on the gate insulating film 62, the semiconductor layer 63, and the etch stop film 65, and then by performing resist-applying, photo-sensing, developing, and photo-etching processes. A pixel electrode 19 including the contact layers 64a and 64b and ITO are formed in the same manner, and the pattern shown in the drawing is obtained by the photo-etching process. Next, each of the banks 66 are provided to protrude on the pixel electrodes 19, the gate insolating film 62, and the etch stop film 65. Liquid droplets of an organic silver compound are ejected between the banks 66 by using the aforementioned pattern formation apparatus 100 so that the source and drain lines can be formed.

Electronic Apparatus

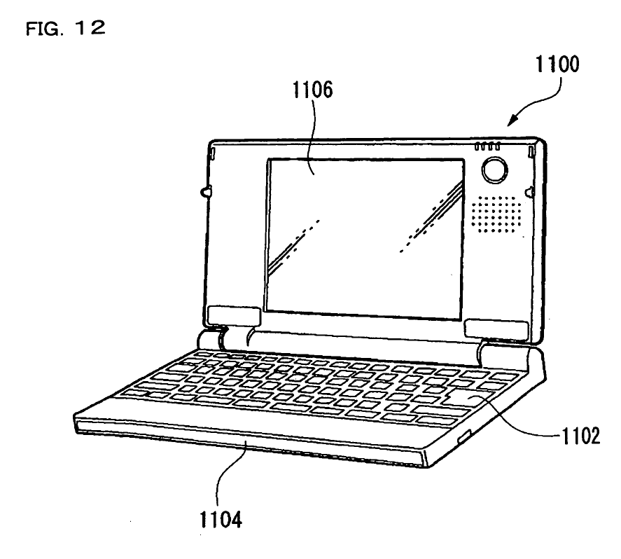

Now, examples of the electronic apparatus of an aspect of the present invention will be described. FIG. 12 is a schematic illustrating construction of a mobile-type personal computer (information processing device) including a display device according to the aforementioned exemplary embodiments. In the drawing, the personal computer 1100 includes a main body 1104 having a keyboard 1102 and a display device unit having the aforementioned electro-optical device 1106. For this reason, it is possible to provide an electronic apparatus including a display portion having high luminescence efficiency and brightness.

In addition to the aforementioned examples, other examples include, for example, a cellular phone, a wristwatch type electronic apparatus, liquid crystal television set, a view finder or monitor direct view type video tape recorder, a car navigation apparatus, a pager, an electronic note, a calculator, a word processor, a work station, a television phone, a POS terminal, an electronic paper, an apparatus having a touch panel and the like. The electro-optical device of an aspect of the present invention may be adapted to display unit of these electronic apparatus. In addition, the electronic apparatus of the present exemplary embodiment may include other various electro-optical devices, such as a liquid crystal device, an organic electro-luminescent display device, and a plasma type display device.

Although the foregoing description has been made of exemplary embodiments of the present invention with reference to the accompanying drawings, the present invention is not limited to the above exemplary embodiments. Various shapes of components or their combinations in the above described examples are simply exemplary ones. Therefore, various modifications may be made thereto based on design requirements without departing from the appended claims.

What is claimed is:

1. A pattern formation method of forming a film pattern by disposing liquid droplets of a functional solution on a substrate, the method comprising:
filling a passage, including a liquid droplet ejection head to dispose the liquid droplets and a conduit to feed the functional solution to the liquid droplet ejection head, with purified water;
filling the passage with a solvent dissolving both a solvent contained in the functional solution and the purified water;
filling the passage with the solvent contained in the functional solution;
forming banks corresponding to the film pattern on the substrate; and
disposing the liquid droplets into grooves between the banks with the liquid droplet ejection head.

2. A pattern formation method of forming a film pattern by disposing liquid droplets of a functional solution on a substrate, the method comprising:
filling a passage, including a liquid droplet ejection head filled with a predetermined storage solution and a conduit to feed the functional solution to the liquid droplet ejection head, with a first solvent dissolving the storage solution;
filling the passage with a second solvent dissolving both the first solvent and a solvent contained in the functional solution;
filling the passage with the solvent contained in the functional solution;
forming banks corresponding to the film pattern on the substrate; and
disposing the liquid droplets into grooves between the banks with the liquid droplet ejection head.

3. The pattern formation method according to claim 1,
the method further comprising:
filling the passage with the functional solution after filling the passage with the solvent contained in the functional solution.

4. The pattern formation method according to claim 1,
the functional solution exhibiting electrical conductivity by thermal or optical treatments.

5. A device manufacturing method, comprising:
forming a film pattern on a substrate,
the film pattern formed on the substrate by the pattern formation method according to claim 1.

6. An electro-optical device, comprising:
a device manufactured by using the device manufacturing method according to claim 5.

7. An electronic apparatus, comprising:
the electro-optical device according to claim 6.
